(19) United States
(12) Patent Application Publication
(10) Pub. No.: US 2020/0190367 A1
(43) Pub. Date: Jun. 18, 2020

(54) SELF-ADHESIVE TAPE COMPRISING A PET SUBSTRATE WITH HIGH LAMINAR STRENGTH

(71) Applicant: TESA SE, Norderstedt (DE)

(72) Inventors: Gero MATZ, Düsseldorf (DE); Ingo NEUBERT, Norderstedt (DE); Bernhard MÜSSIG, Seevetal (DE)

(73) Assignee: TESA SE, Norderstedt (DE)

(21) Appl. No.: 16/628,718

(22) PCT Filed: Jun. 26, 2018
(86) PCT No.: PCT/EP2018/067016

§ 371 Date: Jan. 6, 2020

(30) Foreign Application Priority Data
Jul. 6, 2017 (DE) 10 2017 006 359.1

(51) Int. Cl. C09J 7/38; C09J 7/24; B32B 27/08; C08K 3/013

(52) U.S. Cl. CPC C09J 7/38; C09J 7/24; C08G 63/183; C08K 3/013; B32B 27/08

(57) ABSTRACT

The invention relates to an adhesive tape containing a substrate film, comprising at least one film layer, and at least one adhesive compound layer, the substrate film being biaxially oriented and at least one of the at least one film layers containing 80 to 99% by weight polyethylene terephthalate as the base polymer and 1 to 20% by weight, preferably 2 to 15% by weight, most preferably 5 to 10% by weight of an additive polymer, the weight percentages relating to the polymer component, characterized in that the additive polymer has a glass transition temperature T_{G} that lies at least 10 K, preferably at least 20 K, below the glass transition temperature T_{G} of polyethylene terephthalate.

This application is a 371 of PCT/EP2018/067016, filed Jun. 26, 2018, which claims foreign priority benefit under 35 U.S.C. § 119 of German Patent Application No. 10 2017 006 359.1, filed Jul. 6, 2017, the disclosures of which are incorporated herein by reference.

The invention relates to an adhesive tape comprising a carrier film, comprising at least one film layer, and at least one layer of pressure sensitive adhesive, the carrier film being biaxially oriented and at least one of the at least one film layer comprising 80 to 99 wt % of polyethylene terephthalate as base polymer and 1 to 20 wt % of an additive polymer, the weight fractions being based in each case on the polymer component, and also to the use of this adhesive tape.

An important property of carrier films which are employed in adhesive tapes is their split resistance. The split resistance in the three spatial directions may be different and may be differently influenced. As a result of the orientation of films in x and y direction, for example, there is an increase in the strength in these directions, but, correspondingly, there is an attenuation of the strength in the z direction (perpendicular to the film plane). It is, for instance, common knowledge that commercially available biaxially oriented polypropylene films have attenuated split resistance in the z direction, specifically as a result of shock loading. For polyester films (PET films), in contrast, this effect is barely known, because the split resistance of polyester films is very high by comparison. In the course of using pressure sensitive adhesives with very high peel adhesion to the bond substrate, it has been found that exposure to force certainly results in the splitting of the film in the case of adhesive tapes including such pressure sensitive adhesives. This is especially true of adhesive tapes with a pigmented film with carbon black or titanium dioxide, for example.

Portable electronic products very often use windows made of plastic or glass. Known examples are PDAs, tablets or cellphones (smartphones) for example. The function of the windows is to protect the underlying display. Examples of customary materials besides glass are polymethyl methacrylate or polycarbonate. A basic function of the window is a high transparency, so that the image from the imaging unit (display) is transmitted to the viewer without losses in light intensity and with as little distortion as possible. The windows may also have further, ancillary functions. Oftentimes, for example, antiscratch lacquers are applied so that the window does not suffer scratching under frequent use. Other specialty functions include, for example, mirror functions, which may be achieved by metallization of the window, for example. The windows are secured to the casing on at least two sides by means of a pressure-sensitive adhesive tape. It is usual for this purpose to use a pressure-sensitive adhesive tape in the form of a precisely fitting diecut. The diecuts are commonly produced using pressure-sensitive adhesive tapes which comprise a biaxially oriented PET film and which are furnished on both sides with a pressure sensitive acrylate adhesive. Such diecuts are also used for the fixing of camera lenses, for example.

There is a trend first for the LCD and OLED displays used to become increasingly large and secondly for the cellphones to become increasingly flat. Consequences include first an ever larger window and second ever smaller frame widths for bonding, so as to produce likewise a larger effective display. Smaller bond areas necessitate higher peel adhesion forces on the part of the layers of pressure sensitive adhesive, and more effective pretreatment for increasing adhesion to the parts to be joined—by cleaning or priming, for example. As a result of this, in some cases the split resistance of the film becomes the weak point in the bonded assembly. This is especially the case for pigmented films. In that case the film splits in the interior into two plies, with the bonded parts each retaining a thin layer of adhesive and also part of the film layer. Moreover, the trend to ever thinner electronic devices with displays requires not only increasingly more strongly bonding pressure sensitive adhesives but also a reduced layer thickness, so diminishing the damping effect of the layers of pressure sensitive adhesive under shock loading.

Another increasing requirement is that imposed on the bonding quality. It is nowadays usual for the windows likewise to have a touch panel function, via which the cellphone can be operated. As a result of the multiplicity of functions of new cellphones, furthermore, they are becoming more intensely used. This use is also associated with particular stresses. Especially in the case of the devices with relatively large displays, there is a risk of the window, or even the entire display, breaking out under shock loading as a result, for example, of impact or drop. In that case the bond may fail specifically by splitting of the PET carrier film of the pressure-sensitive adhesive tape. For design reasons a frequent requirement is that the diecut of the pressure-sensitive adhesive tape must be opaque, thus having very low light transmittance. The opacity is achieved through the use of a PET carrier film filled with pigments such as carbon black, for example. The use of inorganic color pigments, however, results in an additional attenuation of the split resistance of the carrier film. Such films have a particularly strong tendency, in particular, toward splitting in the z direction. The skilled person is aware that biaxially oriented polypropylene films exhibit very low split resistance, especially if they include fillers. In the course of orientation, lenticular vacuoles may form around the fillers, meaning that in the μm range the film already has regions in which the film is split into two layers. Attempts are therefore being made to use a black organic die in polyester film, rather than a pigment based on carbon black, in order to avoid such effects in the PET film. With thin films, unfortunately, the imperviosity to light is not satisfactory.

A risk of splitting of the PET carrier film also exists in the case of adhesive masking tapes for the finishing of vehicle bodies. It affects especially adhesive masking tapes which are exposed for relatively long periods to significant temperature load during the baking (curing) of the layers of automobile finish. On removal from the cathodic deposition finish, especially at relatively high speeds, there may be splitting of the carrier film of the adhesive masking tape.

It was an object of the present invention, therefore, to provide an adhesive tape having a PET carrier film which exhibits significantly improved split resistance, and does so even when the carrier film is colored with pigments.

In experiments with pigment-colored carrier films, surprisingly, it has been found that a defined carbon black masterbatch in the polyester film improves, rather than impairs, the split resistance. On closer investigation, it emerged that the binder of this masterbatch is not polyethylene terephthalate (PET) but instead, in particular, polybutylene terephthalate (PBT).

The object of providing an adhesive tape having a PET carrier film with significantly improved splitability is therefore solved in that the additive polymer has a glass transition T_{g} which is at least 10 K, preferably at least 20 K, below the glass transition temperature T_{g} of polyethylene terephthalate.

### BRIEF DESCRIPTION OF THE DRAWINGS

The invention will now be described in greater detail with reference to the drawings, wherein:

FIG. 1 shows a testing setup for assessing the film splitting behavior of an adhesive tape according to the present invention;

FIG. 2 shows a specimen for use in the testing for assessing the film splitting behavior of an adhesive tape according to the present invention;

FIGS. 3a and 3b show the specimen applied to a steel plate;

FIGS. 4a and 4b show the specimen and steel plate attached to and protruding from a test plate;

FIG. 5 shows a test weight; and

FIGS. 6a and b show securement of the specimen, steel plate, test plate, and test weight to a stationary, immobile frame as a part of the testing system.

As a result of the accompanying use of the second polymer, referred to as additive polymer, with a lower glass transition temperature, in addition to the polyethylene terephthalate (PET), the biaxially oriented carrier film enjoys a higher split resistance and hence the adhesive tape enjoys a greater tear resistance.

An additive polymer is a polymer which is added to but not identical to the polyethylene terephthalate. The fraction of the additive polymer in the film is more preferably 2 to 15 wt %, especially 5 to 10 wt %, the weight fractions being based in each case on the polymer component. The additive polymer is preferably a homopolymer or copolymer of polybutylene terephthalate.

In the determination of the glass transition temperature T_{g}, the results obtained may differ if the determination method is not comparable. The temperatures should therefore be taken from the following reference: Polymer Handbook by J. Brandrup et al., 4th edition, volume 1, ISBN 0-471-48171-8. Where plural values are stated for a polymer, the average value is authoritative. Where an additive polymer has a plurality of glass transition temperatures, as in the case of block copolymers such as Hytrel™, the lower temperature is authoritative. In the case of polymers which are not described in the reference, the glass transition temperature is ascertained by DSC (heating rate 20 K/min). If even this method does not furnish an unambiguous result, the temperature may be found by calculation, as described in chapter 6 of Properties of Polymers by D. W. van Krevelen, 4th edition, ISBN 978-0-08-054819-7.

Polyethylene terephthalate in the sense of the present invention refers to a polycondensate of ethylene glycol and terephthalic acid that is preferably a homopolymer but may also be present as a blend or in pure form as a copolymer—for example, PET G™. In that case a comonomer such as diethylene glycol or cyclohexanedioldimethanol, for example, is present in fractions preferably of not more than 5 wt %, more preferably of not more than 1 wt %.

The glass transition temperature T_{g} of polyethylene terephthalate (PET) is 345 K.

The additive polymer is preferably a polyester (other than polyethylene terephthalate) and more preferably a homopolymer or copolymer of polybutylene terephthalate (PBT). Copolymer examples are block copolymers of PBT and polytetramethylene glycol (tradename, for example, Hytrel™).

Examples of particularly suitable additive polymers, with the glass transition temperature stated, are:
polybutylene terephthalate (PBT), T_{g}=333 K; PBT manufacturers are, for example:
   Arnitel (DSM)
   Celanex (Ticona)
   Crastin (DuPont)
   Pocan (Lanxess)
   Ultradur (BASF)
   Valox (Sabic Innovative Plastics)
   VESTODUR (Evonik Industries AG)
Hytrel™ block copolymer, T_{g}=230 K±40 K. Other Tg values are possible.
polyisobutylene phthalate, T_{g}=291 K
polybutylene adipate, T_{g}=223 K
poly-3-hydroxybutyrate, T_{g}=233 K
poly-4-hydroxybutyrate, T_{g}=223 K
SCONA TSPOE 1002 GBLL (maleic anhydride-grafted copolymer of ethylene and octene from Byk Kometra GmbH); T_{g}=218 K
poly(trimethylene glycol) terephthalate, T_{g}=316 K

A further group of suitable additive polymers are core-shell particles of the kind used as impact tougheners in rigid PVC, PMMA or ABS. Their production is described in U.S. Pat. No. 6,605,672 B1, for example. These are particles consisting of a core composed of a generally crosslinked polymer of low glass transition temperature (common monomers are butadiene and butyl acrylate), and of a shell composed of a polymer which is not tacky at room temperature. The shell, with a high glass transition temperature, keeps the additive free-flowing. Particularly suitable additives, on the basis of UV stability and thermal stability, are those having a core of polybutyl acrylate and a shell of ZB-21 ZB-50 from Zibo Huaxing Additives Co. Ltd., T_{g}=240 K.

The adhesive tape of the invention is produced by extrusion of polyethylene terephthalate and one or more additive polymers to form a primary film, biaxial orientation of this film, and furnishing with a (pressure-sensitive) adhesive layer. After orientation, the film is preferably annealed in a hot tunnel in order to reduce shrinkage. The pressure-sensitive adhesive layer is applied preferably on both sides by coating and is based more preferably on polyacrylate. In one preferred embodiment the pressure-sensitive adhesive layer is anchored by corona or plasma treatment or application of a primer coat. One preferred embodiment comprises the lamination of the carrier film with a release paper or release film (with silicone coating), there being a layer of pressure sensitive adhesive between the two components. Another preferred embodiment comprises a film composed of a mixture of polyethylene terephthalate raw material with a pigmented additive polymer, especially with a masterbatch of carbon black and polybutylene terephthalate.

Biaxially oriented PET films may further advantageously comprise organic or inorganic particles for adjusting the surface topography or optical qualities (gloss, cloudiness, etc.). Examples of such particles are calcium carbonate, apatite, silicon dioxide, titanium dioxide, aluminum dioxide, crosslinked polystyrene, crosslinked polymethyl methacrylate, zeolites, and other silicates such as aluminum silicates. These particles, referred to as antiblocking agents, are used particularly in the outer layers in order to improve the winding properties. Particularly preferred particles here are calcium carbonate or silicon dioxide. These compounds are used in general in amounts of 0.01 to 5 wt %, preferably of 0.01 to 0.5 wt %, and ideally at 0.01 to 0.3 wt %. These fractions are based on the film material as a whole.

The fraction of particles, preferably color pigments, in the film layer is preferably in the range from 0.5 to 10 wt %, more preferably in the range of 1 to 8 wt %, based on the total weight of the film layer.

The composition of the film layer is then especially (the weight fractions based in each case on the total weight of the film layer) as follows:
70 to 98.5 wt % of polyethylene terephthalate as base polymer, preferably 77 to 97 wt %
1 to 20 wt % of additive polymer, preferably 2 to 15 wt %
0.5 to 10 wt % of particles, preferably color pigments, preferably 1 to 8 wt %

According to one variant of the invention, the at least one film layer consists of 80 to 99 wt % of polyethylene terephthalate as base polymer and 1 to 20 wt %, preferably 2 to 15 wt %, especially 5 to 10 wt % of an additive polymer, the weight fractions being based in each case on the polymer component.

The particle size (d₅₀) of the particles used, in other words the median, is at the production stage generally between 0.1 and 0.8 μm and preferably between 0.3 and 5.5 μm and very preferably between 0.5 and 2.5 μm. The use of particles having a d₅₀ of larger than 8 μm intensifies the impression of a grey surface and reduces the gloss of the film surface.

The particle sizes are analyzed by laser diffraction (ISO13320-1 (1999)).

### Black Films

Biaxially oriented polyester films and also black polyester films colored by carbon black are well known and are described in EP 2 631 263 A1, for example. In the invention, besides carbon black as black pigment, it is also possible with preference to use aniline black, black iron(II,III) oxide, carbon nanotubes or other pigments for coloring.

To meet the light imperviosity requirement, the carrier film is colored black preferably with carbon black. To avoid die deposits at high pigment concentrations, one embodiment is that of a 3-layer film composed of a black-colored middle layer and two non-colored outer layers. The additive polymer is located in the middle layer. Optionally, at least one of the outer layers may also comprise an additive polymer of the invention. In one preferred embodiment the additive polymer is colored in the form of a masterbatch, where the additive polymer forms the matrix for the pigment, for example, thus simplifying metering at the extrusion stage.

Carbon black raises the electrical conduction properties of the film and particularly of the melt, and this may lead to difficulties in electrostatic placement of the extruded but as yet unoriented film onto the chill roll. For this reason, preferably no layer contains more than 10 wt % of carbon black and ideally no layer contains more than 8 wt % of carbon black. A high level of carbon black in a layer may also raise the risk of formation of carbon black agglomerates, which can be recognized as black inclusions within the film.

The carbon black used for carbon black coloring of the film is particularly that produced by the furnace process. As well as industrial carbon blacks from the furnace process, carbon blacks from the channel acetylene or the thermal process may also be used. Among publications to describe these processes is EP 2 364 846 A1.

Effective incorporation of the carbon blacks for coloring the film, with a low count of agglomerates, which appear as specks, can be ensured if the carbon blacks used have a BET surface area (measured according to ASTM D 6556-04) of greater than 40 and less than 500 m²/g, preferably a BET surface area of greater than 100 and less than 250 m²/g. Also preferred are carbon blacks having an OAN (Oil Absorption Number, according to ASTM D 2414 with DBP) of greater than 40 and less than 200 ml/100 g.

These carbon blacks are available commercially. Examples of suitable carbon blacks are Printex F 85 from Orion Engineered Carbons GmbH, Germany or Black Pearls of grades 4350 and 4750 from Cabot Inc., USA.

The transparency of the film of the invention is to be preferably less than 8%, more preferably less than 6%, and ideally less than 4.5%. Greater film transparency reduces the black impression, and this may in turn lead to a yellowish brown impression.

### White Films

To obtain films distinguished by a low transparency, the films may be colored, apart from with black pigments, with white pigments as well. Such white films are described in DE 10 2005 058 916 A1 or JP-A-63-220421, for example.

### Black/White Films

A further possibility is a combination of black and white layer. To obtain a film of low transparency, a multilayer—for example, three-layer—film is likewise conceivable, which in one or in two of the three layers is colored with a different pigment from the third layer of the film. A polyester of low transparency, consisting of two white outer layers, having at least a whiteness of 65, and of a base layer, which is colored with carbon black, is described in EP 2 364 846 A1.

### Film Production

To produce the biaxially oriented polyester film it is usual to use polyester raw material (PET) having a standard viscosity (SV as a measure of the molecular weight) in the range from 700 to 1200. Particularly preferred are SV values above 800. A high chain length at the start of film production is advantageous, since it results in greater strength and/or toughness of the film and also increases the lifetime of the polymer chains for a given rate of degradation. SV values <600 should be avoided here, since these polymer chains have too short a lifetime. SV values >1200, while showing a high lifetime, lead to technical problems in the process producing the film and therefore to disadvantages in terms of the economics of the operation. The production of biaxially oriented polyester films is state of the art and is adequately described in DE 10 2011 009 821 A1, EP 2 186 633 A1, EP 2 631 263 A1, and EP 2 364 846 A1.

### Adhesive Tape and (Pressure Sensitive) Adhesives

The films described can be used directly as carriers for the adhesive tape, with the side intended for subsequent coating with the adhesive being subjected in general to a fluoro treatment, a plasma treatment, a corona pretreatment or else flame pretreatment in order to improve the anchoring of the adhesive on the carrier. The surface of the film may likewise be treated/etched with trichloroacetic acid before being coated with a corresponding adhesive, in order to increase the anchoring force of the adhesive.

A further improvement in the adhesion synonymous with the anchoring of the adhesive on the carrier (or as an alternative treatment) may be accomplished through the use of primers (also called adhesion promoters). With these it is possible on the one hand to tailor the surface energy and on the other hand, for example, to pursue chemical attachment of the elastomeric adhesive component to the carrier when using, for example, isocyanate-containing primers.

Descriptions of the adhesives, and also release varnishes and primers, that are customarily used for adhesive tapes are found for example in the “Handbook of Pressure Sensitive Adhesive Technology” by Donatas Satas (van Nostrand, 1989).

The adhesive applied to one or both sides of the carrier material is preferably a pressure sensitive adhesive, this being an adhesive which permits a durable bond to virtually all substrates even under relatively weak applied pressure and which, after use, can be detached from the substrate again substantially without residue. A pressure sensitive adhesive exerts permanent pressure-sensitive tack at room temperature, thus having a sufficiently low viscosity and a high initial tack, meaning that it wets the surface of the respective bond base even under low applied pressure. The bondability of the adhesive derives from its adhesive properties, and the redetachability from its cohesive properties.

To produce an adhesive tape from the carrier, all known adhesive systems may be recruited. Besides the preferred polyacrylate adhesives, it is also possible to use adhesives based on natural rubber or synthetic rubber, and also silicone adhesives.

Adhesives may be used that are solvent-based, water-based, or else hotmelt systems. Also suitable is an acrylate hotmelt-based adhesive, which may have a K value of at least 20, more particularly greater than 30, and is obtainable by concentrating a solution of such an adhesive to give a system which can be processed as a hotmelt. The concentrating may take place in appropriately equipped tanks or extruders; especially in the context of the accompanying devolatilization, a devolatilizing extruder it is preferred. One such adhesive is described in DE 43 13 008 A1, the content of which is hereby incorporated by reference to become part of this disclosure and invention. The acrylate hotmelt-based adhesive may also have been chemically crosslinked.

In a further embodiment, self-adhesive compositions used comprise copolymers of (meth)acrylic acid and esters thereof having 1 to 25 carbons, maleic, fumaric and/or itaconic acid and/or their esters, substituted (meth)acrylamides, maleic anhydride, and other vinyl compounds, such as vinyl esters, especially vinyl acetate, vinyl alcohols and/or vinyl ethers. The residual solvent content ought to be below 1 wt %.

Particularly preferred is an embodiment using a pressure sensitive adhesive which comprises at least one polyacrylate. This is a polymer which is obtainable by radical polymerization of acrylic monomers, a term taken to include methylacrylic monomers, and optionally of further, copolymerizable monomers.

A polyacrylate crosslinkable with epoxide groups is preferred. Accordingly, monomers or comonomers used are preferably functional monomers that are crosslinkable with epoxide groups; used especially here are monomers with acid groups (particularly carboxylic, sulfonic or phosphonic acid groups) and/or hydroxyl groups and/or acid anhydride groups and/or epoxide groups and/or amine groups; monomers containing carboxylic acid groups are preferred. It is especially advantageous if the polyacrylate comprises copolymerized acrylic acid and/or methacrylic acid.

Other monomers which can be used as comonomers for the polyacrylate are, for example, acrylic and/or methacrylic esters having up to 30 carbon atoms, vinyl esters of carboxylic acids containing up to 20 carbons, vinyl aromatics having up to 20 carbons, ethylenically unsaturated nitriles, vinyl halides, vinyl ethers of alcohols containing 1 to 10 carbons, aliphatic hydrocarbons having 2 to 8 carbons and one or two double bonds, or mixtures of these monomers.

Monomers of component (c) may advantageously also be selected on the basis that they contain functional groups which support a subsequent radiation crosslinking (by electron beams/UV, for example). Suitable copolymerizable photoinitiators are, for example, benzoin acrylate and acrylate-functionalized benzophenone derivatives. Monomers which support crosslinking by electron bombardment are, for example, tetrahydrofurfuryl acrylate, N-tert-butylacrylamide, allyl acrylate—this recitation is not exhaustive.

The polyacrylate may optionally also be blended with other polymers. Polymers suitable for this purpose include those based on natural rubber, synthetic rubber, styrene block copolymers, EVA, silicone rubber, acrylic rubber, polyvinyl ether.

The pressure sensitive adhesive (PSA) preferably comprises epoxide-based crosslinkers. Epoxide group-containing substances that are used are, in particular, polyfunctional epoxides, in other words those which have at least two epoxide units per molecule (that is, are at least bifunctional). They may be both aromatic and aliphatic compounds.

An adhesive which shows itself likewise to be suitable are low-molecular acrylate hotmelt PSA such as acResin® UV from BASF, for example, and acrylate dispersion PSAs as available, for example, under the tradename Acronal® from BASF.

Likewise used with preference is an adhesive which consists of the group of the natural rubbers or of any desired blend of natural rubbers and synthetic rubbers, with the fraction of the synthetic rubber in the blend being—according to one preferred embodiment—at most equal to the fraction of the natural rubber. Other elastomers may also have been added to the adhesive.

(Natural) rubber adhesives display a good combination of peel adhesion, tack, and cohesion, and also balanced bonding performance on virtually all relevant substrates, and are therefore predestined. General information on rubber adhesives can be found in references including standard works for adhesive tapes, such as, for example, the “Handbook of Pressure Sensitive Adhesive Technology” by Donatas Satas.

Furthermore, in order to enhance their processing qualities, the rubbers may preferably be admixed with thermoplastic elastomers, with a weight fraction of 10 to 50 wt %, based on the total elastomer fraction. Representatives that may be mentioned at this point include, in particular, the especially compatible styrene-isoprene-styrene (SIS) and styrene-butadiene-styrene (SBS) types. Suitable elastomers for blending are also, for example, EPDM or EPM rubber, polyisobutylene, butyl rubber, ethylene-vinyl acetate, hydrogenated block copolymers of dienes (for example, by hydrogenation of SBR, cSBR, BAN, NBR, SBS, SIS or IR; such polymers are known, for example, as SEPS and SEBS), or acrylate copolymers such as ACM. In addition, a 100% system of styrene-isoprene-styrene (SIS) or SEBS has proven suitable.

Crosslinking may be accomplished thermally or by irradiation with UV light or electron beam. For the purpose of thermally induced chemical crosslinking, it is possible to use all known thermally activatable chemical crosslinkers such as accelerated sulfur or sulfur-donor systems, isocyanate systems, reactive melamine, formaldehyde, and (optionally halogenated) phenol-formaldehyde resins and/or reactive phenolic-resin or diisocyanate crosslinking systems with the corresponding activators, epoxidized polyester resins and acrylate resins, and also combinations thereof. The crosslinkers are preferably activated at temperatures above 50° C., especially at temperatures of 100° C. to 160° C., very preferably at temperatures of 110° C. to 140° C. The thermal excitation of the crosslinkers may also be accomplished by means of IR rays or high-energy alternating fields.

It may be mentioned, lastly, that adhesives based on silicone, on polyurethane or on polyolefin are also suitable.

In order to optimize the properties, the self-adhesive composition employed may be blended with tackifiers (resins) and/or with one or more adjuvants such as plasticizers, fillers, pigments, flame retardants, UV absorbers, light stabilizers, aging inhibitors, crosslinking agents, crosslinking promoters or elastomers.

The designation “tackifier resin”, is understood by the skilled person to refer to a resin-based substance which increases the tack.

As tackifier resins it is possible for example to use, as a main component, in particular, hydrogenated and unhydrogenated hydrocarbon resins and polyterpene resins. Those of preferential suitability include hydrogenated polymers of dicyclopentadiene (for example, Escorez 5300 series; Exxon Chemicals), hydrogenated polymers of preferably C₈ and C₉ aromatics (for example, Regalite and Regalrez series; Eastman Inc. or Arkon P series; Arakawa). These polymers may arise through hydrogenation of polymers from pure aromatic streams or else may be based through hydrogenation of polymers on the basis of mixtures of different aromatics. Also suitable are partly hydrogenated polymers of C₈ and C₉ aromatics (for example, Regalite and Regalrez series; Eastman Inc. or Arkon Arakawa), hydrogenated polyterpene resins (for example, Clearon Yasuhara), hydrogenated C₅/C₉ polymers (for example, ECR-373; Exxon Chemicals), aromatic-modified, selectively hydrogenated dicyclopentadiene derivatives (for example, Escorez 5600 series; Exxon Chemicals). The aforementioned tackifying resins may be used either alone or in a mixture.

Hydrogenated hydrocarbon resins are particularly suitable as a blend component for crosslinkable styrene block copolymers, as described in EP 0 447 855 A1, U.S. Pat. Nos. 4,133,731 A, and 4,820,746 A, for example, since the absence of double bonds means that the crosslinking cannot be disrupted.

Furthermore, however, unhydrogenated resins may also be used, if crosslinking promoters such as polyfunctional acrylates, for example, are employed.

Particularly preferred under these conditions is the use of terpene resins based on α-pinene (Piccolyte A Series from Hercules, Dercolyte A Series from DRT), since in addition to high cohesion they also ensure very high adhesion even at high temperatures, and/or ß-pinene and/or δ-limonene.

Other unhydrogenated hydrocarbons as well, unhydrogenated analogues of the hydrogenated resins described above, may alternatively be used. Through the preferred use of crosslinking promoters, it is likewise possible for rosin-based resins to be employed. Because of their low adhesion at elevated temperatures, they are employed principally only as blend components.

Of preferential suitability among others are unhydrogenated, partially hydrogenated or fully hydrogenated resins based on rosin and rosin derivatives, hydrogenated polymers of dicyclopentadiene, unhydrogenated or partially, selectively or fully hydrogenated hydrocarbon resins based on C₅, C₅/C₉ or C₉ monomer streams, polyterpene resins based on α-pinene and/or ß-pinene and/or δ-limonene, hydrogenated polymers of preferably pure C₈ and C₉ aromatics. Aforesaid tackifier resins may be used either alone or in a mixture.

Express reference may be made to the depiction of the state of knowledge in “Handbook of Pressure Sensitive Adhesive Technology” by Donatas Satas (van Nostrand, 1989).

Suitable pulverulent and granular fillers, dies, and pigments are, for example, fibers, carbon black, zinc oxide, titanium dioxide, solid microspheres, hollow or solid glass spheres, silica, silicates, chalk, titanium dioxide, calcium carbonate and/or zinc carbonate.

Moreover, other additives may be added, such as flame retardants, as for example ammonium polyphosphate, electrically conductive fillers (as for example conductive carbon black, carbon fibers and/or silver-coated beads), thermally conductive materials (as for example boron nitride, aluminum oxide, silicon carbide), ferromagnetic additives (as for example iron(III) oxides), aging inhibitors, light stabilizers, ozone protectants, and compounding agents. Suitable aging inhibitors for the adhesives are primary antioxidants such as, for example, sterically hindered phenols, secondary antioxidants such as, for example, phosphites or thiosynergists (thioethers), and/or light stabilizers such as, for example, UV absorbers or sterically hindered amines.

Suitable plasticizers are, for example aliphatic, cycloaliphatic, and aromatic mineral oils, diesters or polyesters of phthalic acid, trimellitic acid or adipic acid, liquid rubbers (for example, nitrile rubbers or polyisoprene rubbers), liquid polymers of butene and/or isobutene, acrylic esters, polyvinyl ethers, liquid resins and plasticizing resins based on the raw materials for tackifier resins, lanolin and other waxes, or liquid silicones.

Suitable crosslinking agents are, for example, phenolic resins or halogenated phenolic resins, melamine resins, formaldehyde resins, and epoxides. Polyfunctional epoxides are oligomers of epichlorohydrin, epoxy ethers of polyhydric alcohols and also their hydroxyethyl ethers, phenol-formaldehyde condensation products, such as phenol alcohols, phenol-aldehyde resins and the like, S- and N-containing epoxides, and also epoxides produced by customary methods from polyunsaturated carboxylic acids or monounsaturated carboxylic acid residues of unsaturated alcohols, glycidyl esters, polyglycidyl esters, which may be obtained by polymerization or copolymerization of glycidyl esters of unsaturated acids or are obtainable from other acidic compounds.

Suitable crosslinking promoters are, for example, maleimides, allyl esters such a triallyl cyanurate, polyfunctional esters of acrylic and methacrylic acid.

Furthermore, the PSA may have been admixed with accelerators for the crosslinking reaction with the epoxides. Accelerators which can be selected include in principle not only primary (NRH₂) and secondary (NR₂H) but also tertiary (NR₃) amines, of course including those which have two or more primary and/or secondary and/or tertiary amine groups, or polyfunctional amines and diamines. Particularly preferred accelerators, however, especially in connection with the reasons stated above, are tertiary amines, such as triethylamine, triethylendiamine, benzyldimethylamine, dimethylaminomethylphenol, 2,4,6-tris(N,N-dimethylaminomethyl)phenol, and N,N′-bis(3-(dimethylamino)propyl)urea, for example. Likewise suitable are phosphate-based accelerators such as phosphines and/or phosphonium compounds, such as triphenylphosphine or tetraphenylphosphonium tetraphenylborate, for example.

The substances recited are in turn not mandatory; the adhesive also functions without their addition individually or in any combination, in other words without resins and/or remaining adjuvants.

The applied thickness of adhesive per layer is preferably in the range from 5 to 250 g/m², especially from 15 to 100 g/m², more preferably in the range from 15 to 60 g/m².

The PSAs may be produced and processed from solution, from dispersion, and from the melt.

The PSAs thus produced may then be placed onto the carrier with the methods that are general knowledge. In the case of the processing from the melt, these may be application methods involving a nozzle or a calender. This kind of processing of an acrylate PSA from the melt is set out in WO 2006/027387 A1, the content of which is hereby incorporated by reference to become part of this disclosure and invention. In the case of methods for applying the adhesive from solution, coatings with knives, doctors or nozzles are known, to mention just a few.

Adhesive Tape Production

In the case of single-sided coating with adhesive, the reverse of the carrier film may have had a reverse-face varnish applied to it, in order to exert a favorable influence on the unwind properties of the adhesive tape wound to form an Archimedean spiral. For this purpose, this reverse-face varnish may have been equipped with silicone compounds or fluorosilicone compounds and also with polyvinylstearylcarbamate, polyethyleneiminestearylcarbamide or organofluorine compounds as substances with abhesive (antiadhesive) effect.

Suitable release agents comprise surfactantlike release systems based on long-chain alkyl groups such as stearylsulfosuccinates or stearylsulfosuccinamates, or else polymers, which may be selected from the group consisting of polyvinylstearylcarbamates, polyethyleneiminestearylcarbamides, chromium complexes of C₁₄ to C₂₈ fatty acids, and stearyl copolymers of the kind described, for example, in DE 28 45 541 A. Likewise suitable are release agents based on acrylic polymers with perfluorinated alkyl groups, silicones or fluorosilicone compounds, based for example on poly(dimethylsiloxanes). With particular preference the release layer comprises a silicone-based polymer. Particularly preferred examples of such release-effect, silicone-based polymers include polyurethane-modified and/or polyurea-modified silicones, preferably organopolysiloxane/polyurea/polyurethane block copolymers, more preferably those as described in example 19 of EP 1 336 683 B1, very preferably anionically stabilized polyurethane-modified and urea-modified silicones having a silicone weight fraction of 70% and an acid number of 30 mg KOH/g. The effect produced by using polyurethane-modified and/or urea-modified silicones is that the products according to the invention combine optimized aging resistance and universal writability with an optimized release behavior. In one preferred embodiment of the invention, the release layer comprises 10 to 20 wt %, more preferably 13 to 18 wt %, of the release-effect constituent.

### Release Liner

To protect the exposed PSA, it is preferably lined with one or more release films and/or release papers. Release papers which can be used include, for example, glassine-coated, HDPE- or LDPE-coated release papers, each having a coating of polydimethylsiloxane as a release ply, in one very preferred design. In a further preferred embodiment of the invention, a release film is used. The release film preferably has a coating of polydimethylsiloxane as release agent on one or both sides. Film materials which can be employed are the typical polymer films. Particularly preferred for use are polyesters (PET, for example) or polyolefin (PP, MOPP, BOPP, PE, for example) films.

The present invention relates, lastly, to the use of the adhesive tape of the invention in the electrical and automobile industries. In the electrical industry, it is used for bonding components in electronic devices; in the automobile industry, adhesive tapes of the invention are employed in particular as adhesive masking tape in the finishing of vehicles.

The PET carrier film of the adhesive tape of the invention has a split resistance which is improved so significantly, and even when the carrier film is colored with pigments or contains other additions such as fillers, that the adhesive tape can be reliably used, even in the face of the particular requirements outlined at the outset, in the bonding of high-value electrical articles or as adhesive masking tape for the finishing of vehicle bodies. In the latter case, this is true especially with regard to those adhesive masking tapes which are exposed for a relatively long time to significant temperature load in the baking (curing) of the automobile paint films. The adhesive tape of the invention likewise exhibits a significant improvement in terms of split resistance at low temperatures. This is of advantage particularly in the case, for example, of transport securement tapes for—for example—refrigerators or other electrical appliances. An important requirement here is that the adhesive tape can be removed from the components without residue, in other words without splitting of the carrier, even at low temperatures of, for example, 0° C.

### Test Methods

180° peel adhesion test (measurement method H1):

A strip with a width of 20 mm of an acrylate PSA applied as a layer to polyester was applied to steel plates which were washed beforehand twice with acetone and once with isopropanol. The pressure-sensitive adhesive strip was pressed onto the substrate ten times with an applied pressure corresponding to a weight of 1 kg. The adhesive tape was immediately thereafter removed from the substrate at a velocity of 300 mm/min and at an angle of 180°. All measurements were conducted at 23° C. and 50% relative humidity. The measurement results are reported in N/cm and are averaged from three measurements.

Film properties test methods

The mechanical properties were determined according to DIN EN ISO 527-3. Film shrinkage is in accordance with DIN 53377.

### Transmission

The transmission of the films was measured using a Specord 250 PLUS UV/Vis spectrometer from Analytik Jena. The wavelength range extended from 360 to 1100 nm. Measurement was carried out with a resolution of 1 nm. To assess the transmission, the value at a wavelength of 550 nm is reported.

SV values (Standard Viscosity)

The standard viscosity SV (DCA) is measured, in accordance with DIN 53726, in dichloroacetic acid at a temperature of 25° C.

Gel permeation chromatography GPC

The figures in this specification stated for the weight-average molecular weight M_{w} and the polydispersity of PD are based on determination by gel permeation chromatography. The determination is made on 100 μL samples having undergone clarifying filtration (sample concentration 4 g/L). The eluent used is tetrahydrofuran with 0.1 vol % of trifluoroacetic acid. The measurement is made at 25° C. The precolumn used is a column of type PSS-SDV, 5μ, 10³ Å, ID 8.0 mm×50 mm. Separation takes place using the columns of type PSS-SDV, 5μ, 10³ Å and also 10⁵ Å and 10⁶ Å each with ID 8.0 mm×300 mm (columns from Polymer Standards Service; detection by differential refractometer Shodex R171). The flow rate is 1.0 ml per minute. The calibration takes place against PMMA standards (polymethyl methacrylate calibration).

Assessment of film splitting behavior

The measurements are conducted under test conditions at 23±1° C. and 50±5% relative humidity. In this test, the preferred embodiment of the adhesive tape of the invention does not exhibit any film splitting.

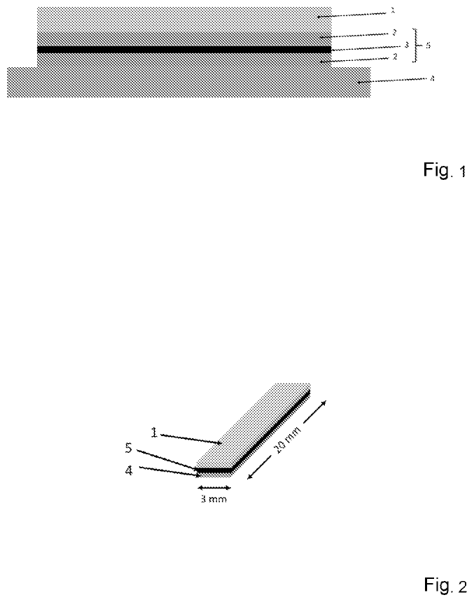

For sample operation, the single-sidedly lined, double-sided adhesive tape (5), under test, consisting of PSA (2) and a PET film (3), is adhered by the open adhesive side, including liner (1), to a further paper or film liner (4) (FIG. 1). This measure is intended to protect the lower and upper adhesive side of the adhesive tape from contamination of any kind during the ongoing sample preparation procedure.

Specimens (5) (rectangular, 20 mm long and 3 mm wide) are cut from this doubly lined adhesive tape (FIG. 2). The specimens for determining the split resistance must be cut into shape using sharp blades. The specimens, furthermore, may also be cut out using an appropriate laser.

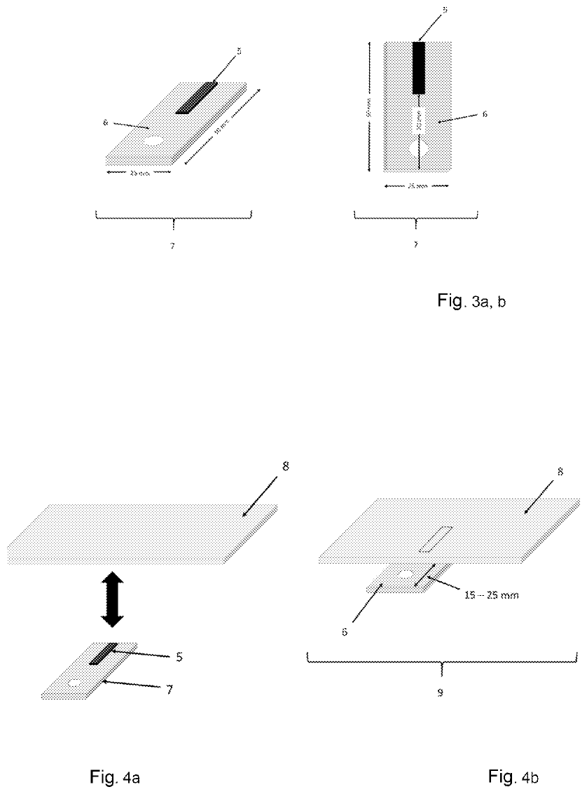

A liner (1 or 4) is removed from one side of the resulting specimens, and the specimen (5) is applied, flush to the lower edge, to the pre-primed side (for example, with the commercial primer 3M 94—applied primer with a suitable cloth and allowed to dry for 15 minutes) of the steel test plate (2×25×50 mm) (6) by gentle stroking over the entire area (FIGS. 3a, b). On one side the steep test plate has an appropriately sized hole to hang the weight that is needed for testing.

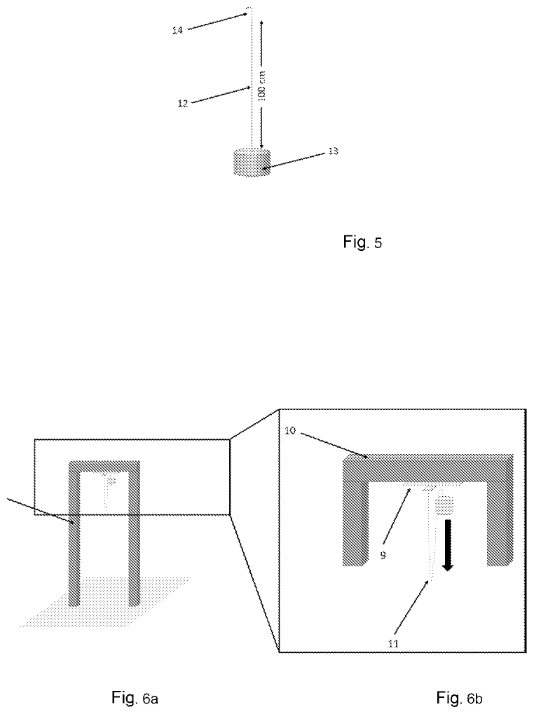

The remaining liner (1 or 4) is removed and the entire test assembly (7) is adhered to the abraded and pre-primed side (apply 3M 94 primer with a suitable cloth and allow to dry for 15 minutes) of an ASTM steel plate (8) (material #1.4301, DIN EN 10088-2, surface 2R). The test plate (6) here must protrude at least 15 mm and at most 25 mm beyond the edge of the test plate (FIG. 4a, b). The entire assembly (9) is fixed in with suitable methods of securement under a rigid, stationary, immobile frame (10) (FIG. 5).

The test weight (11) consists of a steel cable (100 cm, thickness at least 3 mm) (12), a metal weight (500 g) (13), and a suitable facility (14) for securement on the testing element. It should be ensured that the test weight (11) and the securement means (14) are each joined firmly to the steel cable, in order to ensure a constant transmission of force to the test element (5). The test weight is mounted by means of the suitable securement means on the opening in the test plate (6). It should be ensured that, during the securement of the test element and up to the actual test, the weight of the hanging test cable is the maximum weight acting on the test element (FIGS. 6 a and b).

When the test cable has been secured on the test plate (6), the test weight is raised to exactly the height of the test assembly (9) and is dropped vertically in free fall. In the course of this procedure, the test system (9), which is joined by the specimen (5), is destroyed, and the fracture pattern of the double-sided adhesive tape (5) can be assessed.

In order to assess the splitting behavior, ten test elements each of the double-sided adhesive tapes under test are produced in accordance with the method described above and tested as described above. The fracture pattern is classified as film splitting (SPV F) (film splitting in X % of the overall tests), adhesive fracture to the ASTM plate (AHB ASTM P), adhesive fracture to the test plate (AHB PP), adhesive fracture between adhesive and film (AHB F), and film split area (how many % of the film area is split) (SPF F) and cohesive fracture of the PSA (KHB PSA).

The invention is elucidated in more detail below by a number of examples, without wishing thereby to restrict the invention.

### EXAMPLES

### Film Production

The process for producing the films of the invention comprises the following steps:
producing a multilayer film composed of a base layer (B) and at least one outer layer (A), by coextruding and shaping the melts to form a flat melt-film, and subsequently
producing a prefabricated film by cooling the melt-film on a chill roll,
biaxially orienting the prefabricated film in longitudinal and transverse direction, and
heat-setting the biaxially oriented film.

In the production of the film it is ensured that the regrind obtained, for example, as offcuts, in a concentration of around 20 to 60 wt %, based on the total weight of the film, can be resupplied to the extrusion operation without detrimental effect on the physical properties of the film.

### Raw Materials Used in Film Production

All raw materials are antimony-free, meaning that titanium compounds, rather than antimony compounds, were used as transesterification catalysts.

A=polyethylene terephthalate raw material with an SV of 820.
B=99 wt % of polyethylene terephthalate raw material with an SV of 810 and 1 wt % of silicon dioxide (Sylobloc 44H, from Grace Deutschland) with a d₅₀ of 2.55 μm, the Sylobloc was supplied to the polyester during the polycondensation.
C=80 wt % of polyethylene terephthalate raw material with an SV of 820 and 20 wt % of Printex F85 carbon black from Orion Engineered carbons GmbH, Germany, produced by incorporating the carbon black into the PET raw material with a twin-screw extruder. Carbon black properties: BET 200 m²/g, OA 54 ml/100 g measured with DBP, average particle size 16 nm, relevant heavy metals content <6 ppm.
D=87.5 wt % of polybutylene terephthalate raw material with an SV of 700 and 12.5 wt % of Printex F85 carbon black from Orion Engineered carbons GmbH, Germany, produced by incorporating the carbon black into the PBT raw material with a twin-screw extruder. Carbon black properties: BET 200 m²/g, OA 54 ml/100 g measured with DBP, average particle size 16 nm, relevant heavy metals content <6 ppm.
E=50 wt % of polyethylene terephthalate raw material with an SV of 800 and 50 wt % of rutile-type titanium dioxide (type R-104 from DuPont) with an average particle size of 0.3 μm, produced by incorporating the carbon black into the PET raw material with a twin-screw extruder.
F=50 wt % of polybutylene terephthalate raw material with an SV of 700 and 50 wt % of rutile-type titanium dioxide (type R-104 from DuPont) with a mean particle size of 0.3 μm, produced by incorporating the carbon black into the PBT raw material with a twin-screw extruder.
G=polybutylene terephthalate with an SV of 700.

### Black Films

Three polymer mixtures were melted in three twin-screw extruders at 280 to 290° C. The polymer mixtures were brought together in an adapter and placed electrostatically as a film through a slot die onto a chill roll conditioned at a temperature of 40° C. The film was subsequently oriented, first longitudinally and then transversely, in direct succession, under the following conditions.

TABLE 1

| MD stretching | Heating | 75 to 115 | ° C. |
|---|---|---|---|
| | temperature | | |
| | Stretching | 115 | ° C. |
| | temperature | | |
| | Longitudinal | 3.6 | |
| | stretching ratio | | |
| CD stretching | Heating | 100 | ° C. |
| | temperature | | |
| | Stretching | 110 | ° C. |
| | temperature | | |
| | Transverse | 4 | |
| | stretching ratio | | |
| Setting | Temperature | 237-150 | ° C. |
| | Duration | 3 | S |
| | Relaxation | 4.5 | % |

### Film Example (F1) (Black)

### ABA Three-Layer Film

Outer layers consisting of 95 wt % of raw material A and 5 wt % of raw material B. The thickness of the outer layers in the final film is 1 μm. Base layer consisting of 92 wt % of raw material A and 8 wt % of raw material D. The thickness of the base layer of the final film is 10 μm.

TABLE 2

| | | F1 |
|---|---|---|
| Total thickness | μm | 12 |
| Shrinkage MD | % | 1.5 |
| Shrinkage CD | % | 0 |
| Elasticity modulus MD | N/mm² | 4100 |
| Elasticity modulus CD | N/mm² | 4450 |
| Transparency | % | 2.85 |

### Comparative Example (C1) (Black)

### ABA Three-Layer Film

Outer layers consisting of 95 wt % of raw material A and 5 wt % of raw material B. The thickness of the outer layers in the final film is 1 μm. Base layer consisting of 95 wt % of raw material A and 5 wt % of raw material C. The thickness of the base layers of the final film is 10 μm.

TABLE 3

| | | C1 |
|---|---|---|
| Total thickness | μm | 12 |
| Shrinkage MD | % | 1.5 |
| Shrinkage CD | % | 0 |
| Elasticity modulus MD | N/mm² | 4100 |
| Elasticity modulus CD | N/mm² | 4500 |
| Transparency | % | 2.95 |

### Example, White Films

Three polymer mixtures were melted in three twin-screw extruders at 280 to 290° C. The polymer mixtures were brought together in an adapter and placed electrostatically as a film through a slot die onto a chill roll conditioned at a temperature of 40° C. The film was subsequently oriented, first longitudinally and then transversely, in direct succession, under the following conditions.

TABLE 4

| | | | |
|---|---|---|---|
| MD stretching | Heating | 70-120 | ° C. |
| | temperature | | |
| | Stretching | 115 | ° C. |
| | temperature | | |
| | Longitudinal | 3.2 | |
| | stretching ratio | | |
| CD stretching | Heating | 80-135 | ° C. |
| | temperature | | |
| | Stretching | 135 | ° C. |
| | temperature | | |
| | Transverse | 3.8 | |
| | stretching ratio | | |
| Setting | Temperature | 230 | ° C. |
| | Duration | 3 | S |
| | Relaxation | 4.0 | % |

### Film Example (F2) (White)

### ABA Three-Layer Film

Outer layers consisting of 87 wt % of raw material A and 13 wt % of raw material B. The thickness of the outer layers in the final film is 2 μm. Base layer consisting of 87 wt % of raw material A and 13 wt % of raw material F. The thickness of the base layers of the final film is 56 μm.

TABLE 5

| | | F2 |
|---|---|---|
| Total thickness | μm | 60 |
| Shrinkage MD | % | 1.3 |
| Shrinkage CD | % | 0 |
| Elasticity modulus MD | N/mm² | 4000 |
| Elasticity modulus CD | N/mm² | 4300 |
| Transparency | % | 28 |

### Comparative Example (C2) (White)

### ABA Three-Layer Film

Outer layers consisting of 87 wt % of raw material A and 13 wt % of raw material B. The thickness of the outer layers in the final film is 2 μm.

Base layer consisting of 87 wt % of raw material A and 13 wt % of raw material E. The thickness of the base layer of the final film is 56 μm.

TABLE 6

| | | C2 |
|---|---|---|
| Total thickness | μm | 60 |
| Shrinkage MD | % | 1.3 |
| Shrinkage CD | % | 0 |
| Elasticity modulus MD | N/mm² | 3900 |
| Elasticity modulus CD | N/mm² | 4250 |
| Transparency | % | 27 |

### Transparent Films

Three polymer mixtures were melted in three twin-screw extruders at 280 to 290° C. The polymer mixtures were brought together in an adapter and placed electrostatically as a film through a slot die onto a chill roll conditioned at a temperature of 40° C. The film was subsequently oriented, first longitudinally and then transversely, in direct succession, under the following conditions.

TABLE 7

| | | | |
|---|---|---|---|
| MD stretching | Heating | 75-115 | ° C. |
| | temperature | | |
| | Stretching | 115 | ° C. |
| | temperature | | |
| | Longitudinal | 3.6 | |
| | stretching ratio | | |
| CD stretching | Heating | 100 | ° C. |
| | temperature | | |
| | Stretching | 110 | ° C. |
| | temperature | | |
| | Transverse | 4 | |
| | stretching ratio | | |
| Setting | Temperature | 237-150 | ° C. |
| | Duration | 3 | S |
| | Relaxation | 4.5 | % |

### Film Example (F3)

### ABA Three-Layer Film

Outer layers consisting of 95 wt % of raw material A and 5 wt % of raw material B. The thickness of the outer layers in the final film is 1 μm.

Base layer consisting of 93 wt % of raw material A and 7 wt % of raw material G. The thickness of the base layers of the final film is 10 μm.

TABLE 8

| | | F3 |
|---|---|---|
| Total thickness | μm | 12 |
| Shrinkage MD | % | 1.2 |
| Shrinkage CD | % | 0.2 |
| Elasticity modulus MD | N/mm² | 4640 |
| Elasticity modulus CD | N/mm² | 4580 |
| Transparency | % | 92 |

### Comparative Example 3 (C3)

### ABA Three-Layer Film

Outer layers consisting of 95 wt % of raw material A and 5 wt % of raw material B. The thickness of the outer layers in the final film is 1 μm.

Base layer consisting of 100 wt % of raw material A. The thickness of the base layers of the final film is 10 μm.

TABLE 9

| | | C3 |
|---|---|---|
| Total thickness | μm | 12 |
| Shrinkage MD | % | 1.3 |
| Shrinkage CD | % | 0.3 |
| Elasticity modulus MD | N/mm² | 4400 |
| Elasticity modulus CD | N/mm² | 4310 |
| Transparency | % | 93 |

### Examples, Adhesives

All chemicals used are commercially available and listed in the table below.

TABLE 10

| Chemical compound | Trade name | Manufacturer | CAS No. |
|---|---|---|---|
| Bis(4-tert-butylcyclohexyl) | Perkadoxe ®16 | Akzo Nobel | 15520-11-3 |
| peroxydicarbonate | | | |
| 2-Ethylhexyl acrylate | 2-Ethylhexyl | Brenntag | 103-11-7 |
| | acrylate | | |
| n-Butyl acrylate | n-Butyl acrylate | Rohm & Haas | 141-32-2 |
| Acrylic acid | Acrylic acid | BASF | 79-10-7 |
| Terpene-phenolic-based | Sylvarese ® TP 95 | Arizona | |
| tackifier resin | | Chemicals | |
| Tetraglycidyl | Erisys GA 240 | CVC Specialty | 63738-22-7 |
| meta-xylenediamines | | Chemicals Inc. | |
| 2,2’-Azobis(2- | Vazo ® 64 | DuPont | 78-67-1 |
| methylpropionitrile), AIBN | | | |

Described below is the preparation of the starting polymer. The polymers studied are produced conventionally via a free radical polymerization in solution.

### Base Polymer BP1

A reactor conventional for radical polymerizations was charged with 47.5 kg of 2-ethylhexyl acrylate, 47.5 kg of n-butyl acrylate, 5 kg of acrylic acid and 66 kg of acetone/isopropanol (92.5:7.5). After nitrogen gas had been passed through the reactor for 45 minutes with stirring, the reactor was heated up to 58° C. and 50 g of AIBN were added. The external heating bath was subsequently heated to 75° C. and the reaction was carried out constantly at this external temperature. After one hour a further 50 g of AIBN were added, and after 4 hours the batch was diluted with 20 kg of acetone/isopropanol mixture.

After 5.5 hours and again after 7 hours, portions of 150 g of bis(4-tert-butylcyclohexyl) peroxydicarbonate were added for reinitiation. After a reaction time of 22 hours, the polymerization was terminated and the batch was cooled to room temperature. The polyacrylate has an average molecular weight of Mw=386 000 g/mol, polydispersity PD (Mw/Mn)=7.6.

### Blending of the PSA and Production of the Double-Sided Adhesive Tape

### PSA 1

40 wt % of the resin TP 95, based on the dry weight of the polymer, is added to the base polymer BP1. A solids content of 38% is established by addition of benzine. The mixture of polymer and resin is stirred until it can be seen that the resin has completely dissolved. Next 0.075 wt % of the covalent crosslinker Erysis GA 240 is added, based on the dry weight of the polymer. The mixture is stirred at room temperature for 15 minutes. The homogeneous adhesive is coated onto the films F1, F2 F3, C1, C2 and C3. Immediately prior to coating, the films are pretreated by corona on both sides. The corona dose is selected so that the films directly after corona treatment have a surface energy of >52 mN/cm. The films were coated on both sides with 100 g/m² per side of the pressure sensitive acrylate adhesive PSA 1.

The technical adhesive properties of the double-sided adhesive tapes on various standard substrates, by means of measurement method H1, are reproduced in table 11.

TABLE 11

| | Unit | PSA1 |
|---|---|---|
| Peel adhesion, steel | [N/cm] | 12.5 |
| Peel adhesion, glass | [N/cm] | 14.6 |
| Peel adhesion, | [N/cm] | 12 |
| polycarbonate | | |

### Results of Split Test

To assess the splitting behavior, the individual double-sided adhesive tapes are tested as described above. All results of the failure areas are reported in percent.

TABLE 12

| | | | | | AHB | | |
|---|---|---|---|---|---|---|---|
| | | | | KHB | ASTM | AHB | AHB |
| Adhesive | Film | SPV F | SPF F | PSA | P | PP | F |
| PSA 1 | F1 | 0 | 0 | 0 | 95 | 5 | 0 |
| PSA 1 | F2 | 0 | 0 | 0 | 60 | 40 | 0 |
| PSA 1 | F3 | 0 | 0 | 0 | 90 | 10 | 0 |
| PSA 1 | C1 | 100 | 70 | 0 | 30 | 0 | 0 |
| PSA 1 | C2 | 70 | 40 | 0 | 40 | 20 | 0 |
| PSA 1 | C3 | 20 | 10 | 0 | 60 | 30 | 0 |

SPV F = splitting behavior of film (film splitting in X % of the total tests)
SPF F = film split area (how many % of the films is split)
KHB PSA = cohesive fracture within the adhesive
AHB ASTM P = adhesive fracture to the ASTM plate
AHB PP = adhesive fracture to the test plate
AHB F = adhesive fracture between adhesive and film

The results of the split test show clearly that film splitting in double-sided adhesive tapes under strong impactlike load can be prevented only through the combination of strongly adhering adhesives and impact-modified, biaxially oriented polyester films (films F1 to F3). Likewise clear is the adverse effect of inorganic pigments, from examples C1 to C3.

1. An adhesive tape comprising a carrier film comprising at least one film layer, and at least one layer adhesive,
where the carrier film is biaxially oriented and at least one film layer of the at least one film layer comprises 80 to 99 wt % of polyethylene terephthalate as base polymer and 1 to 20 wt % of an additive polymer, the weight fractions being based in each case on the polymer component,
wherein
the additive polymer has a glass transition temperature T_{g} which is at least 10 K below the glass transition temperature T_{g} of polyethylene terephthalate.

2. The adhesive tape as claimed in claim 1, wherein the additive polymer is a homopolymer or copolymer of polybutylene terephthalate.

3. The adhesive tape as claimed in claim 1, wherein at least one film layer of the at least one film layer further comprises at least one color pigment.

4. The adhesive tape as claimed in claim 1claim 1, wherein the color pigment is selected from the group consisting of carbon black, titanium dioxide, black iron(II,III) oxide, carbon nanotubes, barium sulfate, zinc sulfide, and zinc oxide.

5. The adhesive tape as claimed in claim 3, wherein the fraction of color pigment in the film layer is from 0.5 to 10 wt % based on the total weight of the film layer.

6. The adhesive tape as claimed in claim 1, wherein the adhesive is a pressure sensitive adhesive.

7. The adhesive tape as claimed in claim 1, wherein the carrier film has a thickness of 2 to 250 μm.

8. Method of using the adhesive tape as claimed in claim 1 for the bonding of electronic devices or as adhesive masking tape for the finishing of vehicles.
